(19) United States
(12) Patent Application Publication
(10) Pub. No.: US 2004/0027390 A1
(43) Pub. Date: Feb. 12, 2004

(54) Control system for electrical equipment, a software structure for GUI processing, and a method for providing a GUI for controlling an electrical equipment group

(76) Inventors: Toshitaka Yamato, Kobe-shi (JP); Tatsuo Ito, Kobe-shi (JP); Shinichi Hayashi, Kobe-shi (JP)

Correspondence Address: CHRISTIE, PARKER & HALE, LLP, 350 WEST COLORADO BOULEVARD, SUITE 500, PASADENA, CA, 91105, US

(21) Appl. No.: 10/616,631

(22) Filed: Jul. 9, 2003

(30) Foreign Application Priority Data
Aug. 6, 2002 (JP) 2002-228771

(51) Int. Cl. G09G 5/00

(52) U.S. Cl. 345/806

(57) ABSTRACT

The present invention relates to a control system for electrical equipment comprising an electrical equipment group or groups including at least one piece of electrical equipment and a control unit or units connected to said electrical equipment group or groups wherein:

a GUI for controlling said electrical equipment group or groups has a dual structure comprising a functional GUI with respect to the function(s) of said electrical equipment and a main GUI with respect to said whole control system for electrical equipment;

said electrical equipment has a functional GUI data storage means for storing GUI data for said functional GUI; and

said control unit has a main GUI data storage means for storing GUI data for said main GUI and a GUI processing software storage means for storing a GUI processing software for providing said GUI based on each of said GUI data for said functional GUI and said main GUI and for controlling said electrical equipment.

It provides a control system for electrical equipment, which allows an easy update of a GUI for controlling the electrical equipment group(s), corresponding to a change in electrical equipment.

### BACKGROUND OF THE INVENTION

1. Field of Invention

The present invention relates to a control system for electrical equipment comprising an electrical equipment group or groups including at least one piece of electrical equipment and a control unit or units connected to the electrical equipment group or groups.

2. Description of the Related Art

In a control system for electrical equipment comprising an electrical equipment group or groups including at least one piece of electrical equipment, for example vehicular equipment and the like, and a control unit or units connected to the electrical equipment group or groups, a GUI (Graphical User Interface) for controlling the electrical equipment group or groups is commonly provided therewith.

In the prior art, for providing the GUI, a software program for defining the state transition of the GUI screen, the movement, layout, and design of button(s) on the GUI screen and the like, and for controlling electrical equipment in response to a user's operation on the GUI screen has been typically created as one program for each series of products.

However, in the case wherein, as described above, a GUI processing software for controlling electrical equipment is created as one program for each series of products, the efficiency of development (productivity) of the software tends to be low, because the whole program has to be reviewed and modified when new electrical equipment is added to the electrical equipment group or groups and/or a function of a piece of electrical equipment is improved.

In some cases, the design and/or operativity of the GUI may have to be modified in accordance with user's preference, even without any change to the electrical equipment. In this case, similarly to the above, the whole program of the GUI processing software has to be reviewed and modified. In particular, when the electrical equipment is intended to be used in a vehicle, the GUI must be modified in accordance with the area where the vehicle is sold, because vehicles, to which the electrical equipment is fitted, are often sold in various parts of the world.

### SUMMARY OF THE INVENTION

It is the first object of the present invention to provide a control system for electrical equipment comprising an electrical equipment group or groups including at least one piece of electrical equipment and a control unit or units connected to the electrical equipment group or groups which allows easy update of a GUI for controlling the electrical equipment group or groups, corresponding to the addition and/or removal and/or change of electrical equipment.

It is the second object of the present invention to provide a software structure for GUI processing, which provides a GUI for controlling the electrical equipment group or groups, which can be easily updated, corresponding to the addition and/or removal and/or change of electrical equipment, in the control system for electrical equipment comprising an electrical equipment group or groups including at least one piece of electrical equipment and a control unit or units connected to the electrical equipment group or groups.

The first object of the present invention is achieved by a control system for electrical equipment comprising an electrical equipment group or groups including at least one piece of electrical equipment and a control unit or units connected to said electrical equipment group or groups, wherein:

a GUI for controlling said electrical equipment group or groups has a dual structure comprising a functional GUI with respect to the function(s) of said electrical equipment and a main GUI with respect to said whole control system for electrical equipment;

said electrical equipment has a functional GUI data storage means for storing GUI data for said functional GUI; and

said control unit has a main GUI data storage means for storing GUI data for said main GUI and a GUI processing software storage means for storing a GUI processing software for providing said GUI based on each of said GUI data for said functional GUI and said main GUI and for controlling said electrical equipment.

The second object of the present invention is achieved by a software structure for GUI processing, in a control system for electrical equipment comprising an electrical equipment group or groups including at least one piece of electrical equipment and a control unit or units connected to said electrical equipment group or groups, providing a GUI for controlling said electrical equipment group(s), wherein:

said GUI has a dual structure comprising a functional GUI with respect to the function(s) of said electrical equipment and a main GUI with respect to said whole control system for electrical equipment;

said software structure for GUI processing comprises functional GUI data defining said functional GUI, main GUI data defining said main GUI, and a GUI processing software for providing said GUI based on each of said GUI data and for controlling said electrical equipment; and

each of said GUI data comprises GUI transition data defining the state transition of a GUI screen and/or the movement of object(s) constituting said GUI and GUI layout data defining the layout and/or design of said object(s).

### BRIEF DESCRIPTION OF THE DRAWINGS

The above objects and features of the present invention will be more apparent from the following description of the preferred embodiments with reference to the accompanying drawings, wherein:

FIG. 1 illustrates the configuration of the control system for electrical equipment according to the present invention;

FIG. 2 illustrates the hierarchical structure of the GUI provided by the control system for electrical equipment according to the present invention;

FIG. 3 illustrates the configuration of the GUI processing software according to the present invention; and

FIG. 4 illustrates the configuration of the GUI processing software according to a preferred embodiment of the present invention.

### DESCRIPTION OF THE PREFERRED EMBODIMENTS

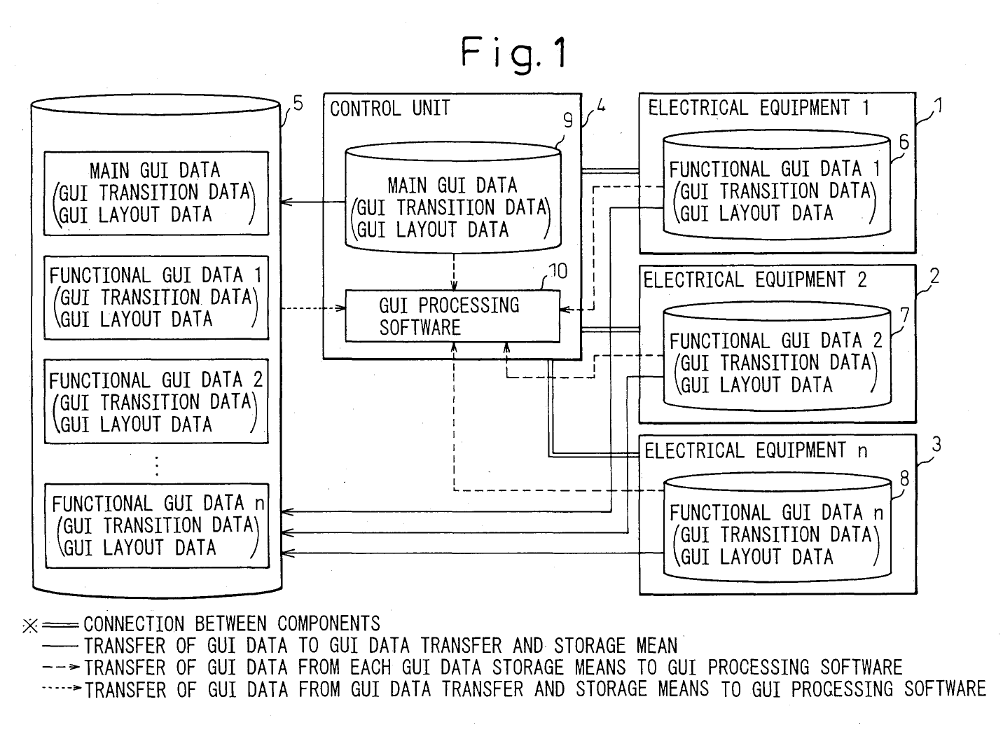

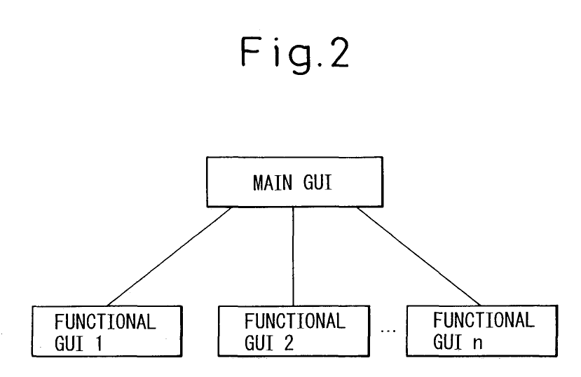

By referring to FIGS. 1 to 4 attached hereto, the control system for electrical equipment will be described more specifically. Although some components according to the preferred embodiments of the present invention are shown in FIGS. 1 to 4, the scope of the present invention is not limited to these certain embodiments.

The control system for electrical equipment shown in FIG. 1 is a control system for electrical equipment comprising an electrical equipment group including a plural of electrical equipment (for example, Electrical Equipments 1 and 2) and Control Unit 4 connected to the electrical equipment group.

The electrical equipment (for example, Electrical Equipments 1 and 2) designate, for example, audio equipment such as a CD player, a CD-R player and/or recorder, a CD-RW player and/or recorder, a MD player and/or recorder, a cassette tape player and/or recorder, and the like, a GPS device and the like, air conditioner, network equipment such as a communications device, a web browsing device, an e-mail receiver/transmitter, and the like, PDA (Personal Digital Assistant), and the like. In particular, as the electrical equipment, for example, vehicular equipment such as car audio equipment, car navigation, car air conditioners, vehicular network equipment, PDA, and the like are contemplated.

As any of the electrical equipment (for example, Electrical Equipments 1 and 2) may be used in a wide variety of combinations depending on the choice made by the users and/or suppliers of the electrical equipment, and the components in these combination may be variable, i.e. it is contemplated that a new component can be added to the combination, an existing component can be removed from the combination, and an existing component can be replaced with a new component, the GUI for controlling such combination of electrical equipment (group of electrical equipment) should be easily updateable, corresponding to the change in the component(s).

The Control Unit 4 is a control unit intended to be connected with and control the electrical equipment, and displays the condition of the electrical equipment, provides a GUI for a user to operate the electrical equipment, causes a state transition of a GUI screen in response to the user's operation on the GUI, and controls the action of the electrical equipment through an operational display device (not shown) such as a liquid crystal touch screen, CRT (Cathode-Ray Tube) touch screen, and the like.

In addition to the above operational display device, the Control Unit 4 may further have an additional control unit (not shown) such as a conventional mechanical switch (which may have a condition displaying function using, for example, a light-emitting diode), and the like. Also, the Control Unit 4 may further have a function to transmit information on a condition of the electrical equipment to be controlled and a user's operation, via voice message.

The GUI provided through the operational display device has a dual structure comprising a functional GUI with respect to the function(s) of the electrical equipment (for example, Electrical Equipments 1 and 2) and a main GUI with respect to the whole control system for the electrical equipment. Such a dual structure of the GUI for controlling the electrical equipment allows the control system to easily update the GUI for controlling the electrical equipment, corresponding to the addition and/or removal and/or change of the electrical equipment (for example, Electrical Equipments 1 and 2) constituting the electrical equipment group or groups.

More specifically, when the electrical equipment constituting the electrical equipment group or groups is added and/or removed and/or changed, the GUI for controlling the electrical equipment can be easily and efficiently updated by, in the main GUI, adding and/or removing and/or changing object(s) for performing the transition to the functional GUI corresponding to the electrical equipment to be added and/or removed and/or changed, rather than by modifying the whole GUI for controlling the electrical equipment.

Preferably, it is desirable that the main GUI has a function to perform the process including display of an initial and/or final screen, display of menu, change of a screen and/or voice message corresponding to a condition of the electrical equipment group or groups, and storage and/or invoking of the last final condition of the control system for the electrical equipment, and the functional GUI has a function to perform the process including control of the corresponding electrical equipment, display of a condition of the corresponding electrical equipment (which may be an information transmission via voice message), and storage and/or invoking of the last final condition of the control system for the electrical equipment.

In the control system for the electrical equipment, GUI data defining the functional GUI with respect to the function(s) of the electrical equipment, for example Functional GUI Data 1 and 2, is stored in a functional GUI data storage means (for example, Functional GUI Data Storage Means 6 and 7) of each of the electrical equipment. Similarly, GUI data defining the main GUI with respect to the whole control system for the electrical equipment is stored in Main GUI Data Storage Means 9 of the control unit. Furthermore, GUI Processing Software 10 for providing the GUI based on each of the GUI data for the functional GUI and the main GUI and controlling the electrical equipment is stored in a GUI processing software storage means (not shown) of the Control Unit 4.

Examples of the storage means include, but are not limited to, hard disks, RAM (Random Access Memory), ROM (Read-only Memory), and the like. In the actual choice of the storage means, the necessity to erase and/or write the stored data should be taken into account. Preferably, the storage means is flash memory.

In addition, the GUI Processing Software 10 may further have function to perform an operation and/or display of an additional control unit such as a conventional mechanical switch (which may have a condition displaying function using, for example, a light-emitting diode and the like), and the like (not shown), other than the operational display device (not shown). Also, the GUI Processing Software 10 may further have a function to make the Control Unit 4 transmit information on a condition of the electrical equipment (for example, Electrical Equipments 1 and 2) to be controlled and a user's operation, via voice message.

Preferably, each GUI data of the functional GUI data and the main GUI data desirably comprises GUI transition data defining the state transition of GUI screen and/or the movement of object(s) constituting GUI and GUI layout data defining the layout and/or design of the object(s).

As described above, distinctly separated GUI transition data and GUI layout data allow more flexible GUI design such as, for example, the ability to change the state transition of GUI screen and/or the movement of object(s) constituting GUI and the layout and/or design of the object(s) on the GUI screen independently with each other, and the like.

Specific examples of the object(s) include, but are not limited to, icons, various buttons (for example, command buttons, toggle buttons, spin buttons, option buttons), check boxes, labels, text boxes, list boxes, comboboxes, scroll bar, and the like. The types of the data displayed on the GUI include text and image (such as moving image and still image).

More preferably, the GUI layout data is desirably described in text. This makes the change of the GUI layout data easier when the layout and/or design of object(s) on GUI screen and the like is to be changed.

Preferably, the control system for electrical equipment desirably further has a GUI Data Transfer and Storage Means 5 for transferring and storing the GUI data of the functional GUI corresponding to the electrical equipment (for example, Electrical Equipments 1 and 2) connected upon the start-up of the control system for the electrical equipment to the Control Unit 4 from the functional GUI data storage means (for example, Functional GUI Data Storage Means 6 and 7) of the electrical equipment. In this case, the GUI Processing Software 10 can provide GUI based on the GUI data stored in the GUI Data Transfer and Storage Means 5, thereby eliminate the need to transfer the GUI data of the functional GUI corresponding to the electrical equipment connected to the Control Unit 4 at every start-up of the control system for the electrical equipment, and reduce the response time in the state transition of the GUI screen.

Examples of the GUI Data Transfer and Storage Means 5 include, but are not limited to, hard disks, RAM, ROM, and the like. In the actual choice of the GUI Data Transfer and Storage Means 5, the necessity to erase and/or write the stored data should be taken into account. Preferably, the GUI Data Transfer and Storage Means 5 is flash memory.

In the control system for electrical equipment, the GUI Data Transfer and Storage Means 5 may be a component distinct from the Control Unit 4, or may be incorporated within the Control Unit 4.

In addition, the GUI Data Transfer and Storage Means 5 may further have a function to transfer and store the GUI data of the main GUI from the Main GUI Data Storage Means 9. Alternatively, the Main GUI Data Storage Means 9 may function as the GUI Data Transfer and Storage Means 5. Both of these embodiments are desirable, because the GUI Processing Software 10 can obtain all the GUI data required to provide GUI from a single storage means.

More preferably, it is desirable that the Control Unit 4 further has a connected electrical equipment storage means (not shown) for registering the electrical equipment connected to the Control Unit 4 upon the last shut-down of the control system for the electrical equipment, and thereby, among the electrical equipment connected to the Control Unit 4 upon the startup of the control system for the electrical equipment, for the electrical equipment consistent with those registered in the connected electrical equipment storage means, as the GUI data of the functional GUI corresponding to the electrical equipment, the GUI data which has been stored in the GUI Data Transfer and Storage Means 5 is used, rather than being newly transferred from the electrical equipment and stored.

Still more preferably, the Control Unit 4 desirably has a GUI data erasing means (not shown) for erasing, from the GUI Data Transfer and Storage Means 5, the GUI data of the functional GUI corresponding to the electrical equipment inconsistent with those connected to the control system for the electrical equipment upon the start-up thereof, among the electrical equipment corresponding to the GUI data registered in the GUI Data Transfer and Storage Means 5.

In the configuration described above, when the electrical equipment connected to the Control Unit 4 is added and/or removed and/or changed, with respect to the electrical equipment which is not added and/or removed and/or changed, as described above, the GUI can be provided, in a reduced response time, based on the GUI data stored in the GUI Data Transfer and Storage Means 5, while, with respect to the electrical equipment which is newly added and/or changed, the GUI can be provided based on the GUI data stored in the GUI Data Transfer and Storage Means 5, the GUI can be provided, in a reduced response time, based on the GUI data stored in the GUI Data Transfer and Storage Means 5, and, further, with respect to the electrical equipment which is removed, the GUI data stored in the GUI Data Transfer and Storage Means 5 can be erased, and, thereby, the storage capacity of the GUI Data Transfer and Storage Means 5 can be efficiently used.

On the other hand, with respect to electrical equipment to be frequently switched on and off, such as PDA and the like, in the configuration described above, GUI data is frequently transferred and stored and erased in the GUI Data Transfer and Storage Means 5 at every time it is switched on and off, and, consequently, the response time of the state transition of the GUI screen corresponding to the electrical equipment may not be able to be reduced.

Accordingly, more preferably, it is desirable that the GUI data erasing means (not shown) further has a function to maintain the GUI data of the functional GUI corresponding to the electrical equipment previously registered, rather than erase it. This allows, for example, a user to register certain electrical equipment (for example, PDA) as electrical equipment “whose GUI data is not erased even when not connected”, and, thus, the GUI data of the functional GUI corresponding to the electrical equipment is maintained in, rather than erased from, the GUI Data Transfer and Storage Means 5 even when the equipment is not connected, the response time of the state transition of the GUI screen of the equipment is reduced when the equipment is connected next time.

Alternatively, the control system for electrical equipment may further have a whole GUI data storage means (not shown) for previously storing GUI data of the functional GUI corresponding to the electrical equipment connectable to the Control Unit 4 and a GUI data extraction means (not shown) for extracting the GUI data corresponding to the electrical equipment connected upon the start-up of the control system for the electrical equipment from the GUI data stored in the whole GUI data storage means, and the GUI Processing Software 10 may provide the GUI based on the GUI data extracted from the whole GUI data storage means by the GUI data extraction means.

The whole GUI data storage means may be any storage means known in the art, such as hard disks, RAM, and ROM.

The capacity of the various storage means for storing GUI data is restricted to a limited value, depending on the choice of the individual storage means. Accordingly, the control system for electrical equipment desirably further has an electrical equipment connection number limiting means (not shown) for limiting the number of the electrical equipment connected to the control unit in accordance with the capacity of the storage means for storing GUI data.

Preferably, the control system for electrical equipment desirably further has a function to update the main GUI and/or the functional GUI by updating all or part of the GUI data stored in the Main GUI Data Storage Means 9 and/or the functional GUI data storage means (for example, Functional GUI Data Storage Means 6 and 7) and/or the GUI Data Transfer and Storage Means 5 based on the GUI data stored in the functional GUI data storage means (for example, Functional GUI Data Storage Means 8) of electrical equipment to be newly connected (for example, Electrical Equipment n).

For example, in the case wherein new electrical equipment (for example, Electrical Equipment n) is added to the electrical equipment group, the GUI can be easily updated such that it can control the newly added equipment, by updating the GUI data of the main GUI stored in the Main GUI Data Storage Means 9 and/or the GUI data of the main GUI stored in the GUI Data Transfer and Storage Means 5, based on the GUI data stored in the functional GUI data storage means (for example, Functional GUI Data Storage Means 8) of the newly added equipment.

Further, for example, in the case wherein the design of the whole GUI is to be updated in association with the addition of new electrical equipment (for example, Electrical Equipment n) to the electrical equipment group, as described above, the design of the main GUI and each functional GUI can be uniformly updated, by updating both or either of the GUI layout data stored in the Main GUI Data Storage Means 9 and each functional GUI data storage means (for example, Functional GUI Data Storage Means 6 and 7) of all the electrical equipment and the GUI layout data of the main GUI and all the functional GUI stored in the GUI Data Transfer and Storage Means 5, based on the whole GUI layout data stored in the functional GUI data storage means (for example, Functional GUI Data Storage Means 8) of the newly added equipment.

Furthermore, in the case wherein the design of the GUI is to be updated as described above, the GUI data for updating the GUI design to a new one may be obtained from external storage media such as CD-ROM, CD-R, CD-RW, MD, and the like (not shown), rather than from the storage means of the electrical equipment constituting the electrical equipment group(s) and/or the control unit as described above. Alternatively, the GUI data for updating the GUI design to a new one may be also obtained via a network such as the internet by utilizing, for example, network equipment (not shown) as one component of the electrical equipment constituting the electrical equipment group(s).

Preferably, it is desirable that the Control Unit 4 is provided with drive(s) (not shown) for the external storage media as described above and, further, has a function to update the main GUI and/or the functional GUI by reading the GUI layout data stored in the external media and, based on the GUI layout data, updating all or part of the GUI data stored in the Main GUI Data Storage Means 9 and/or the functional GUI data storage means (for example, Functional GUI Data Storage Means 6, 7, and n) and/or the GUI Data Transfer and Storage Means 5.

In addition, preferably, the control system for electrical equipment wherein it further comprises a web browser, and the GUI data is described in XML (extensible Markup Language), and it further comprises an XML parser which is shared by the web browser and the GUI processing software is desirable.

As is well known to a person skilled in the art, XML is one of the “metalanguages” constituting “markup languages” which are description languages wherein the structure of screen and modification information are described as text file(s) by surrounding the character strings and the link information of images corresponding to the components constituting a screen to be displayed with the special character string called a “tag”, and can define specific “tags” depending on individual purposes. Thus, as described above, when the GUI data is described in XML, as the GUI data can be read and/or edited using, for example, a text editor, the creation and/or modification and/or verification of such GUI data is desirably easy.

When GUI data is described in XML, it is desirable that the GUI processing software processes data converted from such GUI data described in XML by an XML parser, which is a program for construing XML, comprised in the control system for electrical equipment, rather than directly processes such GUI data.

In addition, as described above, when the control system for electrical equipment, further, has a web browser, it can access various web sites via network such as the internet by utilizing, for example, a network equipment as one component of the electrical equipment constituting the electrical equipment group(s), and display a desired web page on the GUI. This web browser also requires the XML parser in order to browse a web page described in XML.

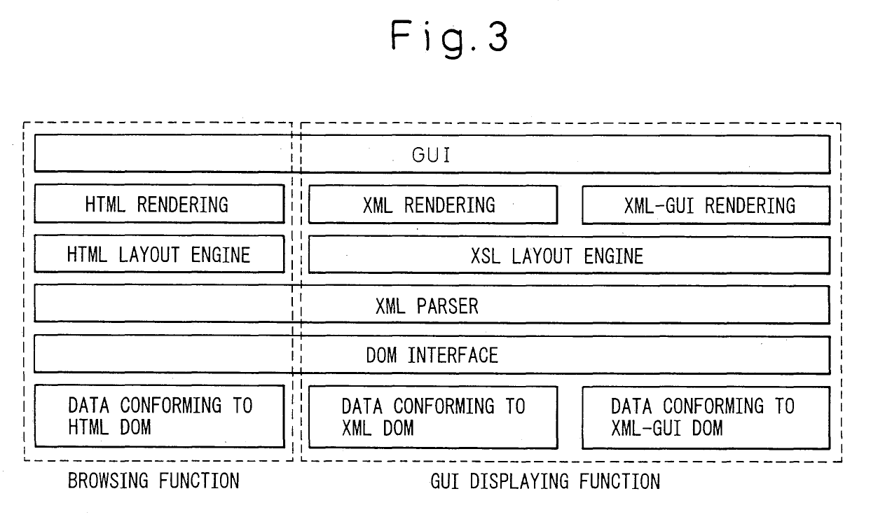

Accordingly, it is desirable that the control system for electrical equipment according to a preferred embodiment of the present invention, as described in FIG. 3, further comprises a web browsing function, the GUI data is described in XML, and the XML parser is shared by the web browsing function and the GUI displaying function provided by the GUI Processing Software 10, because this reduces the size of the program as the whole control system for electrical equipment.

In this case, as described in FIG. 3, the XML parser construes data conforming to various DOM's (Document Object Models), for example, HTML (HyperText Markup Language), XML, and XML-GUI, through a DOM interface, and the web browsing function displays a web page by using an HTML layout engine and an HTML rendering and the GUI displaying function displays a GUI screen by using an XSL (extensible Stylesheet Language) layout engine and an XML and XML-GUI, described hereinafter, renderings.

More preferably, the control system for electrical equipment desirably, further, has a function to convert data which is not GUI data described in XML which can be processed by the GUI Processing Software 10 according to the present invention into GUI data described in XML which can be processed by the GUI Processing Software 10 according to the present invention.

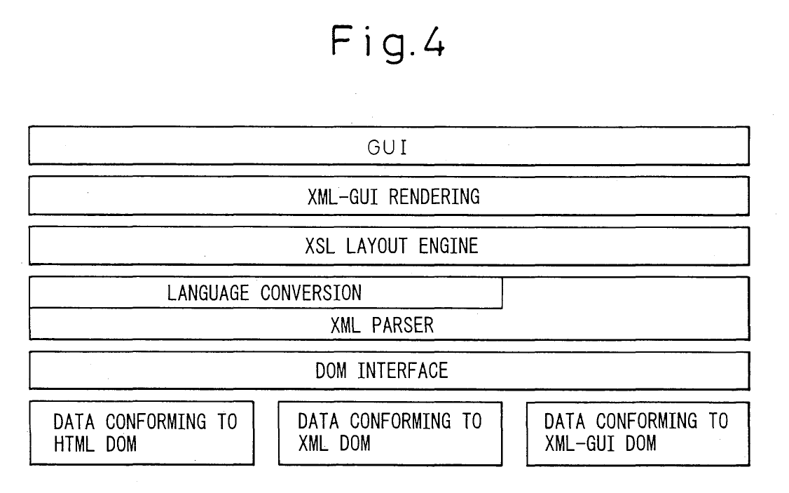

Specifically, the control system for electrical equipment according to a more preferred embodiment of the present invention, as described in FIG. 4, further has a function to convert GUI data described in a language other than the XML-GUI into GUI data described in XML-GUI (language conversion), and, thereby, can utilize data described in a wide variety of languages and/or formats, and can integrate the rendering processes for realizing GUI by using, for example, a single XSL layout engine and a single XML-GUI rendering.

As described above, the “GUI data described in XML which can be processed by the GUI Processing Software 10 according to the present invention” designates GUI data which is described in XML, and wherein, for example, the state transition of GUI screen and/or the movement of object(s) constituting GUI and the layout and/or design of the object(s) on the GUI screen and the like can be changed independently with each other by distinctly separated GUI transition data and GUI layout data, and this corresponds to the technology called “XML-GUI”.

On the other hand, the “data which is not GUI data described in XML which can be processed by the GUI Processing Software 10 according to the present invention” designates data does not correspond to the “GUI data described in XML which can be processed by the GUI Processing Software 10 according to the present invention”, and includes, for example, data described in other language which does not satisfy the above requirements, data described in HTML, and the like.

It is desirable that the control system for electrical equipment has a function to convert the data as described above into “GUI data described in XML which can be processed by the GUI Processing Software 10 according to the present invention”, because this allows the control system to utilize data described in a wide variety of languages and/or formats, and to integrate the rendering processes for realizing a GUI.

The software structure for GUI processing, constituting the control system for electrical equipment is a software structure for GUI processing, in a control system for electrical equipment comprising electrical equipment group(s) including at least one piece of electrical equipment (for example, Electrical Equipment 1 and 2) and the Control Unit 4 connected to said electrical equipment group(s), providing a GUI for controlling said electrical equipment group(s), wherein:

said GUI has a dual structure comprising a functional GUI with respect to the function(s) of said electrical equipment and a main GUI with respect to said whole control system for electrical equipment;

said software structure for GUI processing comprises functional GUI data defining said functional GUI (for example, Functional GUI Data 1 and 2), main GUI data defining said main GUI, and the GUI Processing Software 10 for providing said GUI based on each of said GUI data and for controlling said electrical equipment; and

each of said GUI data comprises GUI transition data defining the state transition of a GUI screen and/or the movement of object(s) constituting said GUI and GUI layout data defining the layout and/or design of said object(s).

As is apparent from the description with regard to the control system for electrical equipment, the software structure is quite useful in that it allows an easy update of a GUI for controlling the electrical equipment group(s), corresponding to the addition and/or removal and/or change of electrical equipment in a control system for electrical equipment comprising electrical equipment group(s) including at least one piece of electrical equipment (for example, Electrical Equipment 1 and 2) and the Control Unit 4 connected to said electrical equipment group(s), and it also allows a more flexible GUI design, for example the ability to change the state transition of GUI screen and/or the movement of object(s) constituting GUI and the layout and/or design of the object(s) on the GUI screen independently with each other, and the like.

The present invention can provide a control system for electrical equipment, which allows easy update of a GUI for controlling the electrical equipment group(s), corresponding to the addition and/or removal and/or change of electrical equipment. The preferred embodiment of the present invention can :reduce the response time of the state transition of the GUI screen in the control system for electrical equipment.

1. A control system for electrical equipment comprising an electrical equipment group including at least one piece of electrical equipment and a control unit or units connected to said electrical equipment group, wherein:
a GUI for controlling said electrical equipment group has a dual structure comprising a functional GUI with respect to the function of said electrical equipment and a main GUI with respect to said whole control system for electrical equipment;
said electrical equipment has a functional GUI data storage means for storing GUI data for said functional GUI; and
said control unit has a main GUI data storage means for storing GUI data for said main GUI and a GUI processing software storage means for storing a GUI processing software for providing said GUI based on each of said GUI data for said functional GUI and said main GUI and for controlling said electrical equipment.

2. A control system for electrical equipment according to claim 1, wherein said main GUI has a function to perform the process including display of an initial and/or final screen, display of menu, change of a screen and/or voice message corresponding to a condition of said electrical equipment group, and storage and/or invoking of the last final condition of the control system for electrical equipment, and said functional GUI has a function to perform the process including control of the corresponding electrical equipment, display of a condition of the corresponding electrical equipment, and storage and/or invoking of the last final condition of the control system for electrical equipment.

3. A control system for electrical equipment according to claim 1, wherein each of said GUI data comprises GUI transition data defining the state transition of a GUI screen and/or the movement of object(s) constituting said GUI and GUI layout data defining the layout and/or design of said object(s).

4. A control system for electrical equipment according to claim 3, wherein said GUI layout data is described in text.

5. A control system for electrical equipment according to claim 1, wherein said system further has a GUI data transfer and storage means for transferring and .storing the GUI data of the functional GUI corresponding to the electrical equipment connected upon the start-up of the control system for electrical equipment to the control unit, and said GUI is provided by said GUI processing software based on the GUI data stored in the GUI data transfer and storage means.

6. A control system for electrical equipment according to claim 5, wherein the GUI data of said main GUI is also transferred to, and stored in, said GUI data transfer and storage means.

7. A control system for electrical equipment according to claim 5, wherein said main GUI data storage means functions also as said GUI data transfer and storage means.

8. A control system for electrical equipment according to claim 5, wherein said control unit further has a connected electrical equipment storage means for registering the electrical equipment connected to the control unit upon the last shut-down of the control system for electrical equipment, and thereby, among the electrical equipment connected to the control unit upon the start-up of the control system for electrical equipment, for the electrical equipment consistent with those registered in the connected electrical equipment storage means, the GUI data which has been stored in said GUI data transfer and storage means is used without newly transferring and storing the GUI data of the functional GUI corresponding to the electrical equipment.

9. A control system for electrical. equipment according to claim 8, wherein said control unit further has a GUI data erasing means for erasing, from said GUI data transfer and storage means, the GUI data of the functional GUI corresponding to the electrical equipment inconsistent with those connected to the control system for electrical equipment upon the start-up thereof, among the electrical equipment corresponding to the GUI data registered in said GUI data transfer and storage means.

10. A control system for electrical equipment according to claim 9, wherein said GUI data erasing means further has a function to maintain the GUI data of the functional GUI corresponding to the electrical equipment previously registered, rather than erase it.

11. A control system for electrical equipment according to claim 1, wherein said system further has a whole GUI data storage means for previously storing GUI data of the functional GUI corresponding to the electrical equipment connectable to said control unit and a GUI data extraction means for extracting the GUI data corresponding to the electrical equipment connected upon the start-up of the control system for electrical equipment from the GUI data stored in the whole GUI data storage means, and said GUI processing software provides said GUI based on the GUI data extracted from the whole GUI data storage means by the GUI data extraction means.

12. A control system for electrical equipment according to claim 5, wherein said system further has an electrical equipment connection number limiting means for limiting the number of the pieces of electrical equipment connected to said control unit in accordance with the capacity of the storage means for storing GUI data.

13. A control system for electrical equipment according to claim 1, wherein said system further has a function to update said main GUI and/or said functional GUI by updating all or part of the GUI data stored in said main GUI data storage means and/or said functional GUI data storage means and/or said GUI data transfer and storage means based on the GUI data stored in the functional GUI data storage means of electrical equipment to be newly connected.

14. A control system for electrical equipment according to claim 1, wherein said control unit is provided with drive(s) for a external storage medium, and further has a function to update said main GUI and/or said functional GUI by reading the GUI layout data stored in the external medium and, based on the GUI layout data, updating all or part of the GUI data stored in said main GUI data storage means and/or the functional GUI data storage means and/or the GUI data transfer and storage means.

15. A control system for electrical equipment according to claim 1, wherein said system further comprises a web browser, and said GUI data is described in XML, and said system further comprises an XML parser which is shared by said web browser and said GUI processing software.

16. A control system for electrical equipment according to claim 15, wherein said system further has a function to convert data, which is not GUI data described in XML which can be processed by said GUI processing software, into GUI data described in XML which can be processed by said GUI processing software.

17. A software structure for GUI processing, in a control system for electrical equipment comprising an electrical equipment group including at least one piece of electrical equipment and a control unit or units connected to said electrical equipment group, providing a GUI for controlling said electrical equipment group, wherein:
said GUI has a dual structure comprising a functional GUI with respect to the function of said electrical equipment and a main GUI with respect to said whole control system for electrical equipment;
said software structure for GUI processing comprises functional GUI data defining said functional GUI, main GUI data defining said main GUI, and a GUI processing software for providing said GUI based on each of said GUI data and for controlling said electrical equipment; and
each of said GUI data comprises GUI transition data defining the state transition of a GUI screen and/or the movement of object(s) constituting said GUI and GUI layout data defining the layout and/or design of said object(s).

18. A method for providing a GUI for controlling an electrical equipment group in a control system for electrical equipment comprising an electrical equipment group including at least one piece of electrical equipment and a control unit or units connected to said electrical equipment group, comprising the steps of:
providing said electrical equipment with a functional GUI data storage means for storing GUI data for a functional GUI with respect to the function of said electrical equipment;
providing said control unit with a main GUI data storage means for storing GUI data for a main GUI with respect to said whole control system for electrical equipment and a GUI processing software storage means for storing a GUI processing software for providing said GUI based on each of said GUI data for said functional GUI and said main GUI and for controlling said electrical equipment; and
providing said GUI for controlling said electrical equipment group, having a dual structure comprising said functional GUI and said main GUI, based on said GUI data for said functional GUI stored in said functional GUI data storage means of said electrical equipment and said GUI data for said main GUI stored in said main GUI data storage means of said control unit, through said GUI processing software stored. in said GUI, processing software storage means of said control unit.
